(19) United States
(12) Patent Application Publication
(10) Pub. No.: US 2024/0211484 A1
(43) Pub. Date: Jun. 27, 2024

(54) INFORMATION PROCESSING METHOD AND INFORMATION PROCESSING APPARATUS

(71) Applicant: Fujitsu Limited, Kawasaki-shi (JP)

(72) Inventors: Anna TANAKA, Yamatokoriyama (JP); Hisashi SUGAWARA, Yokohama (JP); Yutaka KAWAI, Himeji (JP)

(73) Assignee: Fujitsu Limited, (omitted)

(21) Appl. No.: 18/367,127

(22) Filed: Sep. 12, 2023

(30) Foreign Application Priority Data
Dec. 21, 2022 (JP) 2022-203818

(51) Int. Cl. G06F 16/248; G06F 16/2457

(52) U.S. Cl. CPC G06F 16/248; G06F 16/24578

(57) ABSTRACT

A storage unit stores first data including a plurality of first records and second data including a plurality of second records. When a first record has been selected from the first data, a processing unit causes a display device to display, for each of the plurality of second records, a first similarity score between the selected first record and the second record. When a second record has been selected from the second data after the displaying of the first similarity scores, the processing unit causes the display device to display, for each of the plurality of first records, a second similarity score between the selected second record and the first record, together with the first similarity score for each second record.

### CROSS-REFERENCE TO RELATED APPLICATION

This application is based upon and claims the benefit of priority of the prior Japanese Patent Application No. 2022-203818, filed on Dec. 21, 2022, the entire contents of which are incorporated herein by reference.

### FIELD

The embodiments discussed herein relate to an information processing method and an information processing apparatus.

### BACKGROUND

Databases may have different formats for data entry. Therefore, when databases are integrated, entity matching may be performed to identify matching records from the databases.

For example, there has been proposed a system for associating mentioned items, which displays mentioned item candidates in a second document that may be associated with a mentioned item included in a first document, according to priority based on the degree of similarity between keywords included in the mentioned items, and prompts a user to make a selection. In addition, for example, there has been proposed a medical information management system that determines, when the matching ratio between the data of patients exceeds a needed degree of information matching, that the paired patients are the same person, and outputs the medical information of the paired patients in association with each other.

See, for example, Japanese Laid-open Patent Publications No. 2015-028739 and No. 2011-257854.

### SUMMARY

According to one aspect, there is provided a non-transitory computer-readable storage medium storing a computer program that causes a computer to perform a process including: causing, in response to a first record being selected from first data including a plurality of first records, a display device to display, for each of a plurality of second records included in second data, a first similarity score between the selected first record and the each of the plurality of second records; and causing, in response to a second record being selected from the second data after displaying of the first similarity score, the display device to display, for each of the plurality of first records, a second similarity score between the selected second record and the each of the plurality of first records, together with the first similarity score for each of the plurality of second records.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing apparatus according to a first embodiment;

FIG. 2 illustrates an example of an information processing system according to a second embodiment;

FIG. 3 illustrates an example of the hardware configuration of a server;

FIG. 4 illustrates an example of functions of the server;

FIG. 5 illustrates an example of a standard master;

FIG. 6 illustrates an example of an individual company master;

FIG. 7 illustrates an example of an entity matching item selection screen;

FIG. 8 illustrates an example of a similar record search screen (part 1);

FIG. 9 illustrates an example of the similar record search screen (part 2);

FIG. 10 illustrates an example of the similar record search screen (part 3);

FIG. 11 illustrates an example of the similar record search screen (part 4);

FIG. 12 illustrates an example of a record pair list display screen;

FIG. 13 illustrates an example of a record details display screen;

FIG. 14 illustrates an example of screen transitions;

FIG. 15 is a first flowchart illustrating the operation of the server;

FIG. 16 is a second flowchart illustrating the operation of the server;

FIG. 17 is a view for describing how the server assists an entity matching task; and

FIG. 18 illustrates an example of a code conversion table.

### DESCRIPTION OF EMBODIMENTS

An operator in charge of entity matching checks each item of records in databases and selects matching records from the databases. For this process, a computer may be designed to present a record of a database similar to a record selected from another database. However, even if the computer presents such similar records, the operator needs to visually confirm whether these records have a corresponding relationship with each other, which is a heavy burden.

Embodiments will be described below with reference to the accompanying drawings.

### First Embodiment

A first embodiment will be described.

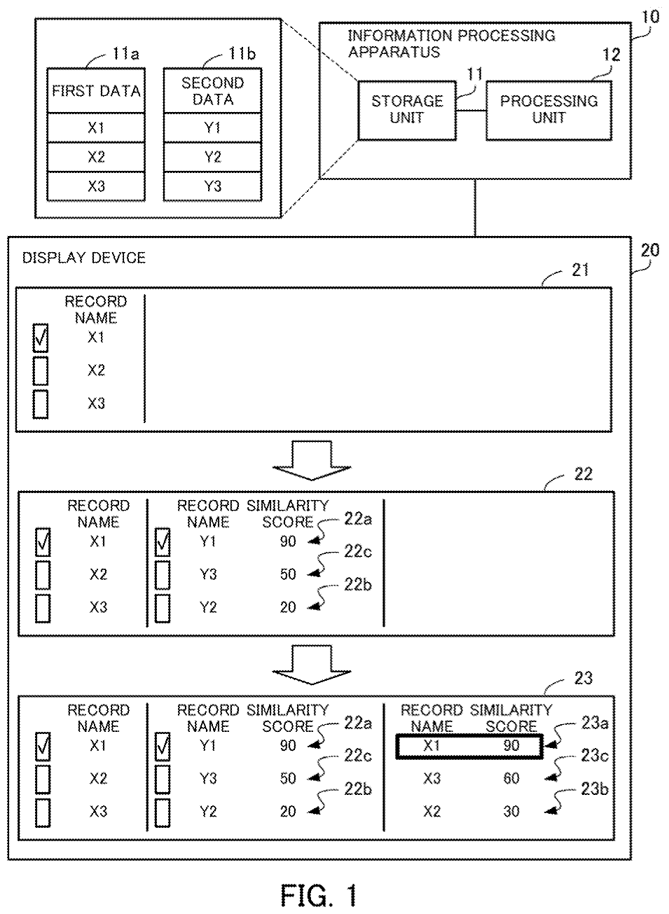

FIG. 1 is a view for describing an information processing apparatus according to the first embodiment.

An information processing apparatus 10 is connected to a display device 20. The information processing apparatus 10 assists a user in an entity matching task through screen display on the display device 20. The display device 20 may be a display connected to the information processing apparatus 10, or alternatively may be a display connected to an apparatus that communicates with the information processing apparatus 10 over a network. The information processing apparatus 10 includes a storage unit 11 and a processing unit 12.

The storage unit 11 may be a volatile storage device such as a random access memory (RAM), or alternatively may be a non-volatile storage device such as a hard disk drive (HDD) or a flash memory. The processing unit 12 may include a central processing unit (CPU), a digital signal processor (DSP), an application specific integrated circuit (ASIC), a field programmable gate array (FPGA), or another. The processing unit 12 may be a processor that executes programs. A “processor” may refer to of a set multiple processors (multiprocessor).

The storage unit 11 stores first data 11a and second data 11b. The first data 11a and second data 11b are databases in which information is registered for items regarding companies or individuals, for example. Note that the first data 11a and the second data 11b may include the same items or different items. The first data 11a contains a plurality of first records. Each first record contains information about each item of the first data 11a. As an example, the first data 11a includes first records with record names “X1,” “X2,” and “X3.” The second data 11b contains a plurality of second records. Each second record contains information about each item of the second data 11b. As an example, the second data 11b includes second records with record names “Y1,” “Y2,” and “Y3.”

The processing unit 12 accepts the selection of a first record from the first data 11a. For example, the processing unit 12 causes the display device 20 to display a screen 21. The screen 21 displays the record names “X1,” “X2,” and “X3” and checkboxes corresponding respectively to the record names. When any checkbox has been selected, the processing unit 12 detects the selection operation and accepts the selection of the first record corresponding to the selected checkbox. Assume now that the first record with record name “X1” has been selected.

When the first record has been selected from the first data 11a, the processing unit 12 calculates first similarity scores 22a, 22b, and 22c between the selected first record and each of the plurality of second records contained in the second data 11b. As an example of the similarity calculation, the processing unit 12 first accepts, from the user, the selection of an item from the first data 11a and an item from the second data 11b. The processing unit 12 compares the selected item of the first record with record name “X1” with the selected item of each of the plurality of second records to calculate a similarity score. If, for example, the selected items contain texts such as company names or addresses, the processing unit 12 calculates an index indicating the degree of matching between the texts as the similarity score.

Assume now that the first similarity score 22a between the first record with record name “X1” and the second record with record name “Y1” is calculated as “90,” the first similarity score 22b between the first record with record name “X1” and the second record with record name “Y2” is calculated as “20,” and the first similarity score 22c between the first record with record name “X1” and the second record with record name “Y3” is calculated as “50.” The processing unit 12 causes the display device 20 to display the first similarity scores 22a, 22b, and 22c for the respective second records. For example, the processing unit 12 causes the display device 20 to display a screen 22 obtained by additionally displaying the first similarity scores 22a, 22b, and 22c in the screen 21.

The screen 22 includes the record names “Y1,” “Y2,” and “Y3” and their corresponding first similarity scores 22a, 22b, and 22c. In the screen 22, the record names and their corresponding first similarity scores are arranged in descending order of their first similarity scores, with the highest first similarity score at the top. The screen 22 also includes checkboxes respectively corresponding to the record names “Y1,” “Y2,” and “Y3.”

After displaying the first similarity scores 22a, 22b, and 22c, the processing unit 12 accepts the selection of a second record from the second data 11b. For example, when any of the checkboxes corresponding to the record names “Y1,” “Y2,” and “Y3” has been selected in the screen 22, the processing unit 12 detects the selection operation and accepts the selection of the second record corresponding to the selected checkbox. Assume now that the second record with record name “Y1” has been selected.

When the second record has been selected from the second data 11b, the processing unit 12 calculates second similarity scores 23a, 23b, and 23c between the selected second record and each of the plurality of first records. For example, the processing unit 12 uses the same calculation method as used for calculating the first similarity scores 22a, 22b, and 22c, to calculate the second similarity scores 23a, 23b, and 23c between the second record with record name “Y1” and each of the plurality of first records.

Assume now that the second similarity score 23a between the second record with record name “Y1” and the first record with record name “X1” is calculated as “90,” the second similarity score 23b between the second record with record name “Y1” and the first record with record name “X2” is calculated as “30,” and the second similarity score 23c between the second record with record name “Y1” and the first record with record name “X3” is calculated as “60.”

The processing unit 12 causes the display device 20 to display the second similarity scores 23a, 23b, and 23c for the respective first records, together with the first similarity scores 22a, 22b, and 22c for the respective second records. At this time, the processing unit 12 highlights the first record selected for displaying the first similarity scores 22a, 22b, and 22c. For example, the processing unit 12 causes the display device 20 to display a screen 23 obtained by additionally displaying the second similarity scores 23a, 23b, and 23c in the screen 22.

The screen 23 includes the record names “X1,” “X2,” and “X3” and their corresponding second similarity scores 23a, 23b, and 23c. In the screen 23, the record names and their corresponding second similarity scores are arranged in descending order of their second similarity scores, with the highest second similarity score at the top. In addition, in the screen 23, the record name “X1” and its corresponding second similarity score 23a are highlighted by a frame.

When a first record and a second record have been selected as a pair after the displaying of the first similarity scores 22a, 22b, and 22c, the processing unit 12 stores information indicating the pair in the storage unit 11. For example, the processing unit 12 stores, in the storage unit 11, information indicating that the first record selected in the screen 21 and the second record selected in the screen 22 are paired. More specifically, the processing unit 12 stores, in the storage unit 11, information indicating that the first record with record name “X1” and the second record with record name “Y1” are paired.

The processing unit 12 repeats the above process until the processing unit 12 receives an input indicating the completion of the pair selection from the plurality of first records and the plurality of second records. When receiving the input regarding the completion of the pair selection, the processing unit 12 identifies first and second records forming each of the pairs stored in the storage unit 11. Then, the processing unit 12 outputs information indicating the corresponding relationship between the information about a first data item included in each identified first record and the information about a second data item included in each identified second record. For example, the processing unit 12 stores, in the storage unit 11, a table indicating the corresponding relationship between the information about the first data item and the information about the second data item.

In this connection, the first data item is, for example, a key item used for searching the first data 11a for a first record among the items of the first data 11a. The second data item is, for example, a key item used for searching the second data 11b for a second record among the items of the second data 11b.

In the above-described information processing apparatus 10, the storage unit 11 stores the first data 11a containing a plurality of first records and the second data 11b containing a plurality of second records. When a first record has been selected from the first data 11a, the processing unit 12 causes the display device 20 to display the first similarity scores 22a, 22b, and 22c between the selected first record and each of the plurality of second records, for the respective second records. After the first similarity scores 22a, 22b, and 22c are displayed, a second record is selected from the second data 11b. The processing unit 12 then causes the display device 20 to display the second similarity scores 23a, 23b, and 23c between the selected second record and each of the plurality of first records, for the respective first records, together with the first similarity scores 22a, 22b, and 22c for the respective second records.

By doing so, the information processing apparatus 10 enables the user doing the entity matching between the first data 11a and the second data 11b to confirm the first similarity scores 22a, 22b, and 22c and the second similarity scores 23a, 23b, and 23c. By confirming the first similarity scores 22a, 22b, and 22c, the user is able to select a second record that is highly likely to have a corresponding relationship with the first record, from the plurality of second records. That is, the information processing apparatus 10 enables the user to identify the corresponding record efficiently.

After that, the information processing apparatus 10 causes the display device 20 to display the second similarity scores 23a, 23b, and 23c together with the first similarity scores 22a, 22b, and 22c. This enables the user to confirm whether the selected first record among the plurality of first records is highly likely to have a corresponding relationship with the second record. As a result, the user is able to determine whether the selected first record and the selected second record have a corresponding relationship with each other, without the need of confirming the details of the selected first and second records. Therefore, the information processing apparatus 10 is able to alleviate the workload involved in the entity matching.

Furthermore, when displaying the second similarity scores 23a, 23b, and 23c, the processing unit 12 highlights the first record selected for displaying the first similarity scores 22a, 22b, and 22c. By doing so, the information processing apparatus 10 enables the user to easily confirm the second similarity score between the selected second record and the selected first record.

In addition, when a first record and a second record are selected as a pair after the first similarity scores 22a, 22b, and 22c are displayed, the processing unit 12 stores information indicating the pair in the storage unit 11. By doing so, the information processing apparatus 10 is able to save the user's entity matching result.

In addition, when receiving an input indicating the completion of the pair selection from the plurality of first records and the plurality of second records, the processing unit 12 identifies first and second records forming each of the pairs stored in the storage unit 11. Then, the processing unit 12 outputs information indicating the corresponding relationship between the information about the first data item included in each identified first record and the information about the second data item included in each identified second record. By doing so, the information processing apparatus 10 makes it possible to make a search using the item of one of the first data 11a and second data 11b to find a corresponding record from the other of the first data 11a and second data 11b. Thus, the information processing apparatus 10 is able to improve the convenience of data.

The following describes the functions of the information processing apparatus 10 in more detail.

### Second Embodiment

A second embodiment will now be described.

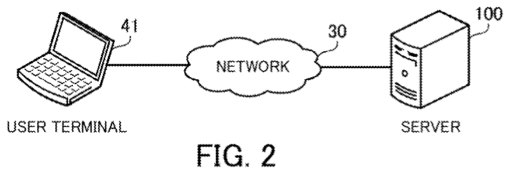

FIG. 2 illustrates an example of an information processing system according to the second embodiment.

The information processing system of the second embodiment includes a user terminal 41 and a server 100. The server 100 is a server computer that manages a standard master containing information on a plurality of companies. The standard master is a table for managing standardized data items for the plurality of companies. The standard master is included in databases that are managed by the server 100. The server 100 receives an individual company master uploaded by the user terminal 41. The individual company master is a table for managing data items defined by an individual company. The individual company master is included in databases that are managed by a server computer the individual company operates. The illustration of the server computer that the individual company operates is omitted in FIG. 2. The server 100 sends screen information to the user terminal 41 to assist a user operating the user terminal 41 to perform entity matching between the records of the individual company master and the records of the standard master.

The server 100 is an example of the information processing apparatus 10 of the first embodiment. The server 100 and user terminal 41 are connected to a network 30. The network 30 is a wide area network (WAN) or the Internet, for example. The server 100 holds the standard master to assist smooth data exchange between companies.

The user terminal 41 is a client computer that the user operates. In this connection, the user terminal 41 may be controlled remotely by the user from another computer. The user terminal 41 displays a screen based on screen information received from the server 100 in a browser, for example.

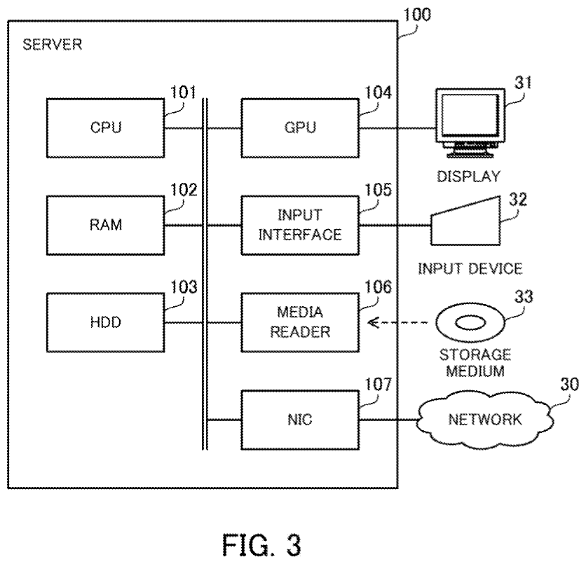

FIG. 3 illustrates an example of the hardware configuration of a server.

The server 100 includes a CPU 101, a RAM 102, an HDD 103, a graphics processing unit (GPU) 104, an input interface 105, a media reader 106, and a network interface card (NIC) 107. In this connection, the CPU 101 is an example of the processing unit 12 of the first embodiment. The RAM 102 or HDD 103 is an example of the storage unit 11 of the first embodiment.

The CPU 101 is a processor that executes program instructions. The CPU 101 loads at least part of a program and data from the HDD 103 to the RAM 102 and executes the program. In this connection, the CPU 101 may include a plurality of processor cores. The server 100 may include a plurality of processors. The processing that will be described below may be performed in parallel by the use of a plurality of processors or processor cores. A set of multiple processors may be called a “multiprocessor,” or simply a “processor.”

The RAM 102 is a volatile semiconductor memory device that temporarily stores programs to be executed by the CPU 101 and data to be used by the CPU 101 in processing. The server 100 may include a different type of memory device than RAM or a plurality of memory devices.

The HDD 103 is a non-volatile storage device that stores software programs such as an operating system (OS), middleware, and application software, and data. The server 100 may include another type of storage device such as a flash memory or a solid state drive (SSD), or a plurality of non-volatile storage devices.

The GPU 104 outputs images to a display 31 connected to the server 100 in accordance with commands from the CPU 101. As the display 31, a desired type of display may be used, such as a cathode ray tube (CRT) display, a liquid crystal display (LCD), a plasma display, or an organic electro-luminescence (OEL) display.

The input interface 105 receives an input signal from an input device 32 connected to the server 100, and outputs the input signal to the CPU 101. As the input device 32, a pointing device such as a mouse, a touch panel, a touchpad, or a track ball, a keyboard, a remote controller, a button switch, or anther may be used. In addition, plural types of input devices may be connected to the server 100.

The media reader 106 is a reading device that reads programs and data from a storage medium 33. Examples of the storage medium 33 include a magnetic disk, an optical disc, a magneto-optical (MO) disk, and a semiconductor memory. Magnetic disks include flexible disks (FDs) and HDDs. Optical discs include compact discs (CDs) and digital versatile discs (DVDs).

The media reader 106 copies, for example, a program and data read from the storage medium 33 to the RAM 102, HDD 103, or another storage medium. The read program may be executed by the CPU 101, for example. In this connection, the storage medium 33 may be a portable storage medium and may be used for distribution of programs and data. In addition, the storage medium 33 and HDD 103 may be called computer-readable storage media.

The NIC 107 is an interface that is connected to the network 30 to communicate with other computers including the user terminal 41 over the network 30. For example, the NIC 107 is connected to a communication device such as a switch or a router with a cable. The NIC 107 may be connected to a communication device wirelessly.

In this connection, the user terminal 41 is implemented with the same hardware configuration as the server 100. A display provided in the user terminal 41 is an example of the display device 20 of the first embodiment.

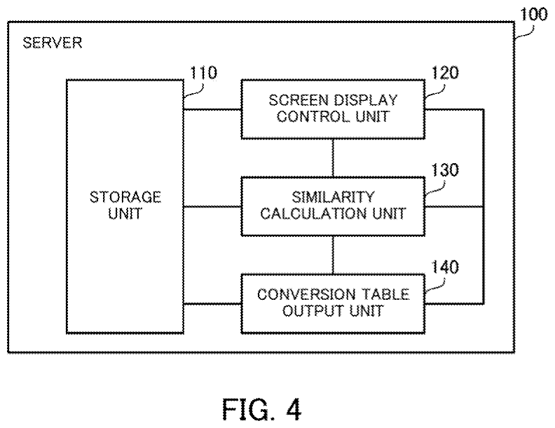

FIG. 4 illustrates an example of functions of the server.

The server 100 includes a storage unit 110, a screen display control unit 120, a similarity calculation unit 130, and a conversion table output unit 140. The storage unit 110 is implemented by using the storage space of the RAM 102 or HDD 103. The screen display control unit 120, similarity calculation unit 130, and conversion table output unit 140 are implemented by the CPU 101 executing programs stored in the RAM 102.

The storage unit 110 stores the standard master, which the server 100 manages, and the individual company master uploaded by the user terminal 41.

The screen display control unit 120 controls the display of a graphical user interface (GUI) on the user terminal 41, and also controls inputs via the GUI from the user terminal 41. The screen display control unit 120 sends screen information for assisting an entity matching task to the user terminal 41 to display a screen on the display of the user terminal 41. In the following, the operation of sending screen information for displaying a screen to the user terminal 41 to display the screen on the display of the user terminal 41 may be expressed as “causing the user terminal 41 to display a screen,” simply.

The screen display control unit 120 accepts the selection of conditions for the entity matching task. For example, the screen display control unit 120 accepts the selection of an item of the individual company master and an item of the standard master (a conversion item for the individual company master and a conversion item for the standard master) that are to be linked to each other in the entity matching. In addition, for example, unit the screen display control 120 accepts the selection of a similarity calculation method to be used in similarity calculation and the selection of a combination of an item (a comparison item for the individual company master) of the individual company master and an item (a comparison item for the standard master) of the standard master that are to be compared in the similarity calculation.

The screen display control unit 120 causes the user terminal 41 to display records of the individual company master. The screen display control unit 120 then accepts the selection of a record (a matching source record) of the individual company master that is to be matched in the entity matching from the displayed records of the individual company master.

When accepting the selection of the matching source record, the screen display control unit 120 causes the user terminal 41 to display the similarity scores between the matching source record and each record of the standard master. The screen display control unit 120 then accepts the selection of a matching target record to be matched to the matching source record from the displayed records of the standard master.

When accepting the selection of the matching target record, the screen display control unit 120 causes the user terminal 41 to display the similarity scores between the matching target record and each record of the individual company master while highlighting the matching source record.

The similarity calculation unit 130 calculates the similarity scores between the matching source record and each record of the standard master and the similarity scores between the matching target record and each record of the individual company master. For example, as the similarity score between the matching source record and a record of the standard master, the similarity calculation unit 130 calculates an index indicating the degree of matching between the text registered in a comparison item of the matching source record and the text registered in a comparison item of the record of the standard master. In this case, the similarity calculation unit 130 may convert predetermined words included in the texts to other words, and then may compare the texts registered in the comparison items to calculate the similarity score. A dictionary that is used for the word conversion may depend on the similarity calculation method accepted by the screen display control unit 120. In addition, the similarity calculation unit 130 may calculate the similarity scores between the matching source record and each record of the standard master by performing relative evaluation among the records of the standard master on the similarity to the matching source record. For example, the similarity calculation unit 130 may calculate the similarity score between the matching source record and a record of the standard master on the basis of the total number of records in the standard master and the position of the record in the ranking of similarity to the matching source record among the records of the standard master.

The conversion table output unit 140 stores information indicating that the matching source record and the matching target record are paired, in the storage unit 110. Then, the conversion table output unit 140 outputs a conversion code table indicating the corresponding relationship between the comparison items of the paired records.

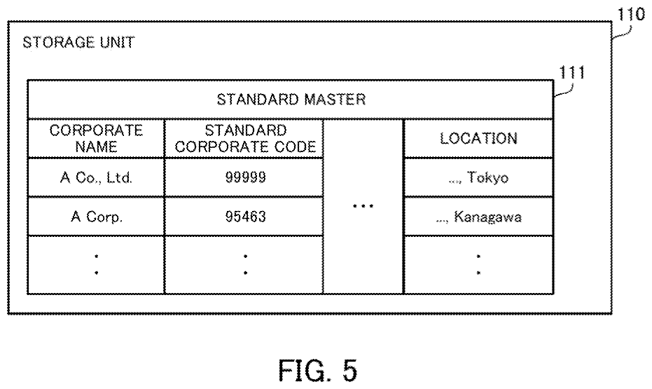

FIG. 5 illustrates an example of the standard master.

A standard master 111 is stored in the storage unit 110 in advance. The standard master 111 includes the following items: Corporate Name, Standard Corporate Code, and Location. The Corporate Name item indicates the name of a corporate. The Standard Corporate Code item indicates the ID of the corporate that is used in the standard master 111. The Location item indicates the location of the corporate.

For example, the standard master 111 includes a record with Corporate Name of “A Co., Ltd.,” Standard Corporate Code of “99999,” and Location of “ . . . , Tokyo.” This record indicates that a corporate named “A Co., Ltd.” has an ID of “99999” as a corporate ID used in the standard master 111 and is located at “ . . . , Tokyo.”

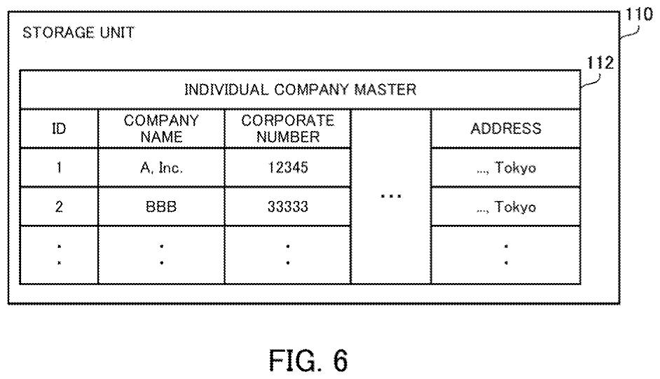

FIG. 6 illustrates an example of the individual company master.

An individual company master 112 is uploaded from the user terminal 41 to the storage unit 110 when an entity matching task is executed. The individual company master 112 includes the following items: ID, Company Name, Corporate Number, and Address. The ID item indicates the ID of a record that is used in the individual company master 112. The Company Name item indicates the name of a company. The Corporate Number item indicates the corporate number of the company. The Address item indicates the address of the company.

For example, the individual company master 112 includes a record with ID of “1,” Company Name of “A, Inc.,” Corporate Number of “12345,” and Address of “ . . . , Tokyo.” This record with ID of “1” indicates that a company named “A, Inc.” has a corporate number of “12345” and is located at “ . . . , Tokyo.”

The following describes screens that the screen display control unit 120 causes the user terminal 41 to display.

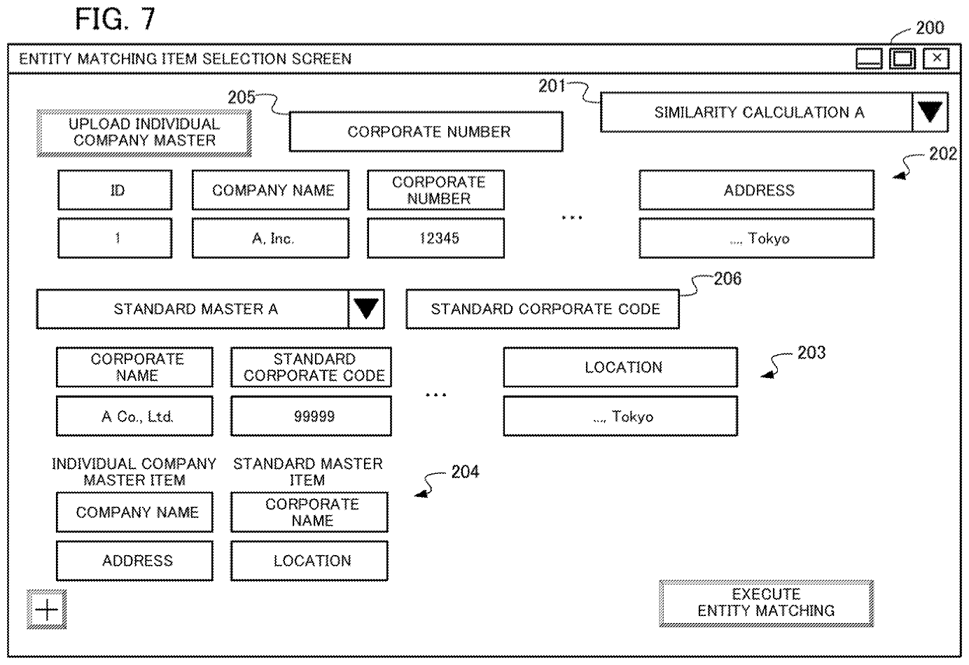

FIG. 7 illustrates an example of an entity matching item selection screen.

An entity matching item selection screen 200 is designed to prompt the user to select setting for the server 100 to assist an entity matching task. The screen display control unit 120 causes the user terminal 41 to display the entity matching item selection screen 200 in response to an access from the user terminal 41. The entity matching item selection screen 200 includes a calculation method pulldown 201, an individual company master display area 202, a standard master display area 203, a comparison item display area 204, and conversion item display areas 205 and 206.

The calculation method pulldown 201 is used for accepting the selection of a calculation method of calculating similarity scores between records of the standard master 111 and records of the individual company master 112. The screen display control unit 120 receives from the user terminal 41 a notification of the calculation method selected with the calculation method pulldown 201.

The individual company master display area 202 is designed to display a sample record from the individual company master 112. When an “Upload Individual Company Master” button has been pressed in the entity matching item selection screen 200, the user terminal 41 uploads the individual company master 112 to the server 100. In response to this, the screen display control unit 120 causes the user terminal 41 to display a sample record from the individual company master 112 in the individual company master display area 202. For example, the individual company master display area 202 displays the items defined in the individual company master 112 and the information about the items registered in a record with ID of “1” in the individual company master 112.

The standard master display area 203 is designed to display a sample record from the standard master 111. When the standard master 111 has been selected from a pulldown menu for selecting a standard master, the user terminal 41 requests the server 100 to display a sample record from the standard master 111. In response to this request, the screen display control unit 120 causes the user terminal 41 to display a sample record from the standard master 111 in the standard master display area 203. For example, the standard master display area 203 displays the items defined in the standard master 111 and the information about the items registered in a record with Corporate Name of “A Co., Ltd.” in the standard master 111.

The comparison item display area 204 is designed to display combinations of comparison items, which are to be compared in the calculation of the similarity score between a record of the standard master 111 and a record of the individual company master 112. When an Add button in the comparison item display area 204 has been pressed, the user terminal 41 prompts the user to select one item from the individual company master 112 and one item from the standard master 111. The user terminal 41 notifies the server 100 of the selected items as a combination of comparison items. The screen display control unit 120 causes the user terminal 41 to display the accepted combination of comparison items side by side in the comparison item display area 204. For example, the comparison item display area 204 displays, as comparison items, “Company Name” from the individual company master 112 and “Corporate Name” from the standard master 111 side by side. In addition, the comparison item display area 204 displays “Address” from the individual company master 112 and “Location” from the standard master 111 side by side.

The conversion item display area 205 is designed to display a conversion item for the individual company master 112. When one item has been selected from the items of the individual company master 112 displayed in the individual company master display area 202, the user terminal 41 detects the selection and notifies the server 100 of the selected item as a conversion item for the individual company master 112. The screen display control unit 120 causes the user terminal 41 to display the accepted conversion item for the individual company master 112 in the conversion item display area 205. For example, the conversion item display area 205 displays “Corporate Number” as a conversion item for the individual company master 112.

The conversion item display area 206 is designed to display a conversion item for the standard master 111. When one item has been selected from the items of the standard master 111 displayed in the standard master display area 203, the user terminal 41 detects the selection and then notifies the server 100 of the selected item as a conversion item for the standard master 111. The screen display control unit 120 causes the user terminal 41 to display the accepted conversion item for the standard master 111 in the conversion item display area 206. For example, the conversion item display area 206 displays “Standard Corporate Code” as a conversion item for the standard master 111.

Furthermore, the entity matching item selection screen 200 includes an “Execute Entity Matching” button. When receiving a notification from the user terminal 41 that the “Execute Entity Matching” button has been pressed, the screen display control unit 120 causes the user terminal 41 to display the next screen. Note that the screen display control unit 120 may accept the selections of a similarity calculation method, comparison items, and conversion items from the user terminal 41, either individually when they are selected or all together when the “Execute Entity Matching” button is pressed.

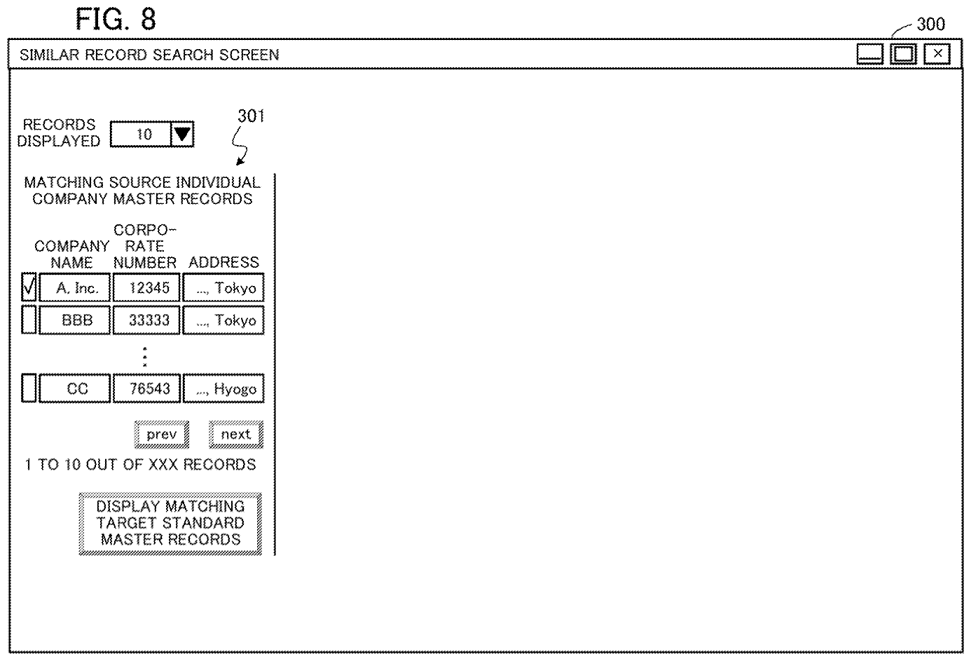

FIG. 8 illustrates an example of a similar record search screen (part 1).

A similar record search screen 300 is designed to assist the entity matching task. When receiving a notification from the user terminal 41 that the “Execute Entity Matching” button has been pressed in the entity matching item selection screen 200, the screen display control unit 120 causes the user terminal 41 to display the similar record search screen 300. The similar record search screen 300 illustrated in FIG. 8 includes a pulldown for setting “Records Displayed,” i.e., the number of records whose information is to be displayed, and an individual company master record display area 301. For example, the Records Displayed is set to 10 in the similar record search screen 300.

The individual company master record display area 301 is designed to accept the selection of a matching source record. The individual company master record display area 301 displays information about the comparison items, information about the conversion item, and a checkbox for each record of the individual company master 112. For example, the individual company master record display area 301 displays the information about the Company Name, Corporate Number, and Address items for each record of the individual company master 112.

When a checkbox has been selected in the individual company master record display area 301, the user terminal 41 detects the selection and notifies the server 100 of the record corresponding to the selected checkbox. The screen display control unit 120 takes the accepted record as a matching source record.

In addition, the individual company master record display area 301 has a “Display Matching Target Standard Master Records” button. When receiving a notification from the user terminal 41 that the “Display Matching Target Standard Master Records” button has been pressed, the screen display control unit 120 causes the similarity calculation unit 130 to calculate the similarity scores between the matching source record and each record of the standard master 111. Here, the similarity calculation unit 130 calculates the similarity scores between the matching source record and each record of the standard master 111 on the basis of the similarity calculation method and the combinations of comparison items selected in the entity matching item selection screen 200. Then, the screen display control unit 120 causes the user terminal 41 to additionally display the similarity scores between the matching source record and each record of the standard master 111 in the similar record search screen 300.

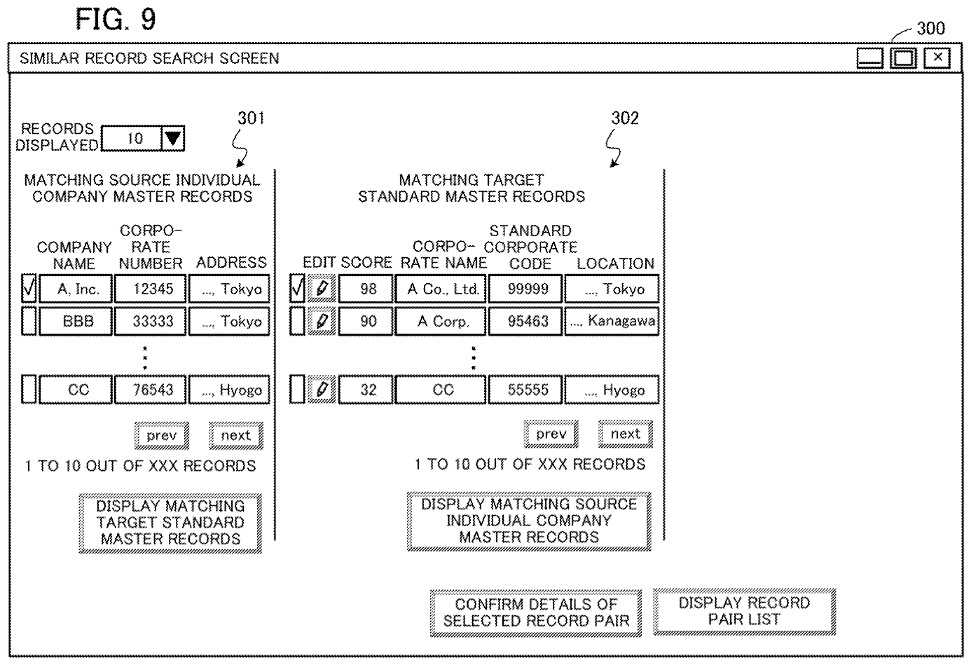

FIG. 9 illustrates an example of the similar record search screen (part 2).

When receiving a notification from the user terminal 41 that the “Display Matching Target Standard Master Records” button has been pressed, the screen display control unit 120 causes the user terminal 41 to additionally display a standard master record display area 302 in the similar record search screen 300. In addition, the screen display control unit 120 causes the user terminal 41 to additionally display a “Confirm Details of Selected Record Pair” button and a “Display Record Pair List” button in the similar record search screen 300.

The standard master record display area 302 is designed to display the similarity scores between the matching source record and each record of the standard master 111 and to accept the selection of a matching target record. For each record of the standard master 111, the standard master record display area 302 displays information about the comparison items, information about the conversion item, a similarity score (Score) between the matching source record and the record, an edit button, and a checkbox. In this connection, the information on the records of the standard master 111 displayed in the standard master record display area 302 is arranged in descending order of their similarity scores with the matching source record, with the information on a record with the highest similarity score at the top.

For example, the standard master record display area 302 displays the information about the Corporate Name, Standard Corporate Code, and Location items for each record of the standard master 111. In addition, for example, standard master record the display area 302 displays, for each record of the standard master 111, the similarity score between the matching source record and the record in a numeric value ranging from 0 to 100.

When a checkbox has been selected in the standard master record display area 302, the user terminal 41 detects this selection and notifies the server 100 of the record corresponding to the selected checkbox. The screen display control unit 120 takes the accepted record as a matching target record. In this connection, when an Edit button has been pressed, the user terminal 41 recognizes that the matching target record is to be re-selected.

In addition, the standard master record display area 302 includes a “Display Matching Source Individual Company Master Records” button. When receiving a notification from the user terminal 41 that the “Display Matching Source Individual Company Master Records” button has been pressed, the screen display control unit 120 causes the similarity calculation unit 130 to calculate the similarity s between the matching target record and each record of the individual company master 112. The similarity calculation unit 130 calculates the similarity scores between the matching target record and each record of the individual company master 112 on the basis of the similarity calculation method and the combinations of comparison items selected in the entity matching item selection screen 200. Then, the screen display control unit 120 causes the user terminal 41 to additionally display the similarity scores between the matching target record and each record of the individual company master 112 in the similar record search screen 300. In this connection, the screen display control unit 120 may accept the selection f the matching target record when the “Display Matching Source Individual Company Master Records” button is pressed.

When receiving a notification from the user terminal 41 that the “Confirm Details of Selected Record Pair” button has been pressed, the screen display control unit 120 causes the user terminal 41 to display a screen for confirming the details of the matching source record and matching target record. In addition, when receiving a notification from the user terminal 41 that the “Display Record Pair List” button has been pressed, the screen display control unit 120 causes the user terminal 41 to display a list of pairs each selected as a matching source record and a matching target record. In addition, when receiving a notification from the user terminal 41 that the “Confirm Details of Selected Record Pair” button or “Display Record Pair List” button has been pressed, the conversion table output unit 140 stores information indicating that the matching source record and matching target record are paired, in the storage unit 110.

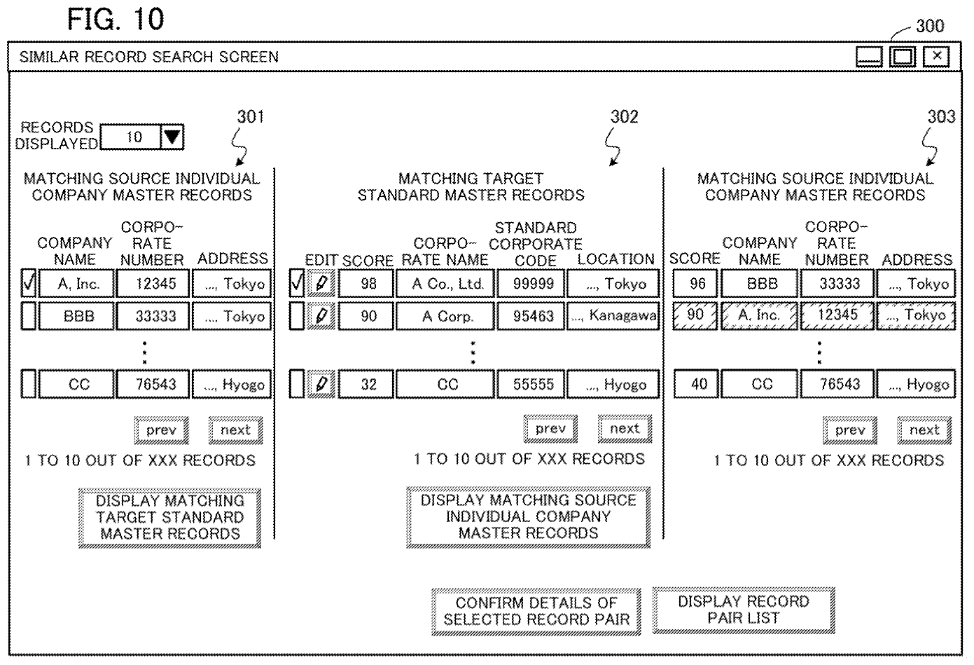

FIG. 10 illustrates an example of the similar record search screen (part 3).

When receiving a notification from the user terminal 41 that the “Display Matching Source Individual Company Master Records” button has been pressed, the screen display control unit 120 causes the user terminal 41 to additionally display an individual company master record display area 303 in the similar record search screen 300.

The individual company master record display area 303 is designed to display the similarity scores between the matching target record and each record of the individual company master 112. For each record of the individual company master 112, the individual company master record display area 303 displays information about the comparison items, information about the conversion item, and the similarity score (Score) between the matching target record and the record. In this connection, the information on the records of the individual company master 112 displayed in the individual company master record display area 303 is arranged in descending order of their similarity scores with the matching target record, with the information on a record with the highest similarity score at the top. In addition, among the information on displayed in the individual company master record display area 303, the information on the matching source record is highlighted.

For example, the individual company master record display area 303 displays the information about the Company Name, Corporate Number, and Address items for each record of the individual company master 112. In addition, for example, the individual company master record display area 303 displays, for each record of the individual company master 112, the similarity score between the matching target record and the record in a numeric value ranging from 0 to 100. Furthermore, for example, the information on the matching source record is displayed in an eye-catching color in the individual company master record display area 303.

In this connection, the similarity score between the matching target record and a record of the individual company master 112 may be calculated on the basis of the total number of records in the individual company master 112 and the position of the record in the ranking of similarity to the matching target record among the records of the individual company master 112. In addition, the similarity score between the matching source record and a record of the standard master 111 displayed in the standard master record display area 302 may be calculated based on the total number of records in the standard master 111 and the position of the record in the ranking of similarity to the matching source record among the records of the standard master 111. Therefore, the similarity score between the matching source record and the matching target record displayed in the standard master record display area 302 may have a different value from the similarity score between the matching source record and the matching target record displayed in the individual company master record display area 303.

The following describes the case where a similarity calculation method (hereinafter, may be referred to as a different calculation method) different the similarity calculation method used for from displaying record search screen 300 is selected after a matching source record and a matching target record are selected in the similar record search screen 300.

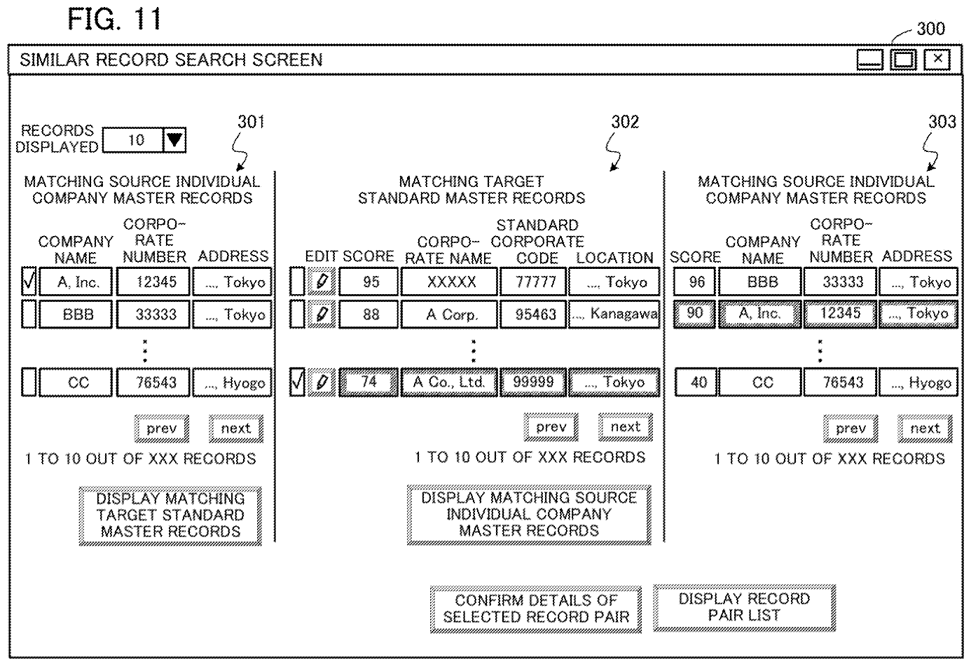

FIG. 11 illustrates an example of the similar record search screen (part 4).

The similar record search screen 300 illustrated in FIG. 11 displays the records of the standard master 111 and the records of the individual company master 112 on the basis of similarity scores calculated with a different calculation method and the matching target record selected in the similar record search screen 300 illustrated in FIGS. 8 to 10. For example, when the different similarity calculation method is selected in the entity matching item selection screen 200 after the matching source record and matching target record are selected as illustrated in FIGS. 8 to 10, the screen display control unit 120 causes the user terminal 41 to display the similar record search screen 300 illustrated in FIG. 11. In this connection, the calculation method pulldown 201 may be provided in the similar record search screen 300. Assume now that the same matching source record as selected in the similar record search screen 300 has been selected in the individual company master record display area 301 of the similar record search screen 300 illustrated in FIG. 11.

The standard master record display area 302 illustrated in FIG. 11 displays the similarity scores between the matching source record and each record of the standard master 111, calculated with the different calculation method. In addition, the information on the records of the standard master 111 displayed in the standard master record display area 302 illustrated in FIG. 11 is arranged in descending order of their similarity scores calculated with the different calculation method, with the information on a record with the highest similarity score at the top. In addition, among the information on the records of the standard master 111 displayed in the standard master record display area 302 illustrated in FIG. 11, the information on the matching target record selected in the similar record search screen 300 illustrated in FIGS. 8 to 10 is highlighted.

The individual company master record display area 303 illustrated in FIG. 11 displays the similarity scores between the matching target record selected in the standard master record display area 302 illustrated in FIG. 11 and each record of the individual company master 112, calculated with the different calculation method. In addition, the information on the records of the individual company master 112 displayed in the individual company master record display area 303 illustrated in FIG. 11 is arranged in descending order of their similarity scores calculated with the different calculation method, with the information on a record with the highest similarity score at the top. In addition, among the information on the records of the individual company master 112 displayed in the individual company master record display area 303 illustrated in FIG. 11, the information on the matching source record selected in the individual company master record display area 301 illustrated in FIG. 11 is highlighted.

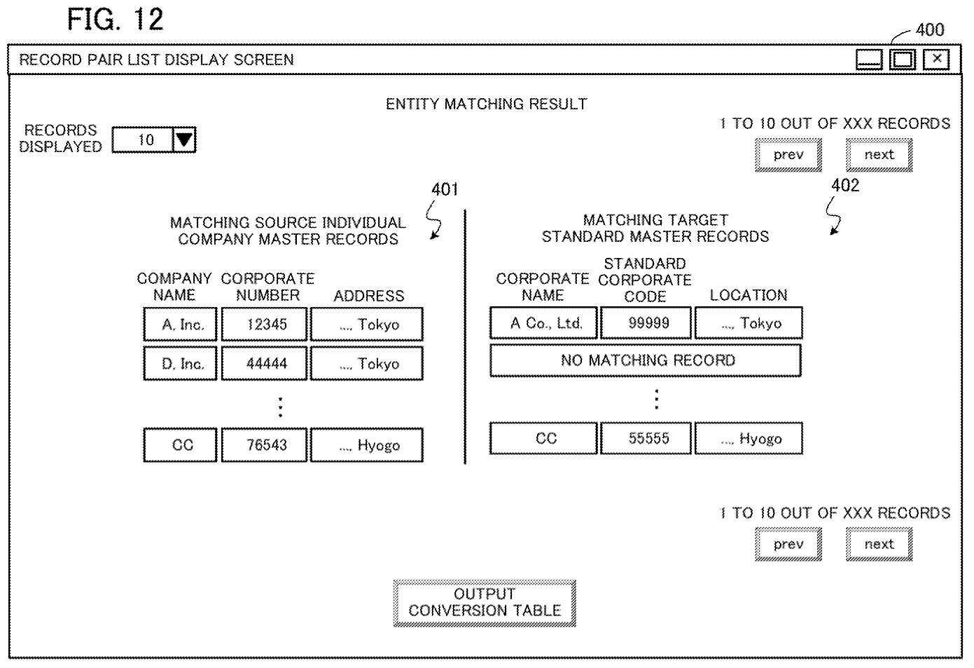

FIG. 12 illustrates an example of a record pair list display screen.

A record pair list display screen 400 is designed to display a list of records selected as pairs of matching source record and matching target record. When receiving a notification from the user terminal 41 that the “Display Record Pair List” button has been pressed in the similar record search screen 300, the screen display control unit 120 causes the user terminal 41 to display the record pair list display screen 400. The record pair list display screen 400 includes an individual company master record display area 401 and a standard master record display area 402.

The individual company master record display area 401 displays information about the comparison items and information about the conversion item for each record of the individual company master 112. For example, the individual company master record display area 401 displays the information about the Company Name, Corporate Number, and Address items for each record of the individual company master 112. In addition, the user terminal 41 accepts the selection of a record displayed in the individual company record display area 401. When receiving a notification from the user terminal 41 that the record has been selected in the individual company master record display area 401, the screen display control unit 120 causes the user terminal 41 to display a screen for confirming the details of the record and the matching target record paired with the record.

The standard master record display area 402 displays the information on the records of the standard master 111 that are matching target records respectively paired with the records of the individual company master 112 displayed in the individual company master record display area 401. The standard master record display area 402 displays information about the comparison items and information about the conversion item for each record of the standard master 111. For example, the standard master record display area 402 displays the information about the Corporate Name, Standard Corporate Code, and Location items for each record of the standard master 111.

In the standard master record display area 402, the information on the matching target records is arranged next to the information on their paired records of the individual company master 112 displayed in the individual company master record display area 401. In this connection, if there is no matching target record for a record of the individual company master 112, for example, a message like “no matching record” indicating that there is no matching target record may be displayed next to the information on the record of the individual company master 112.

In addition, the record pair list display screen 400 includes an “Output Conversion Table” button. When receiving a notification from the user terminal 41 that the “Output Conversion Table” button has been pressed, the screen display control unit 120 causes the conversion table output unit 140 to generate a code conversion table indicating the corresponding relationship between the conversion item of each matching source record and the conversion item of each matching target record. The conversion table output unit 140 generates the code conversion table and stores it in the storage unit 110.

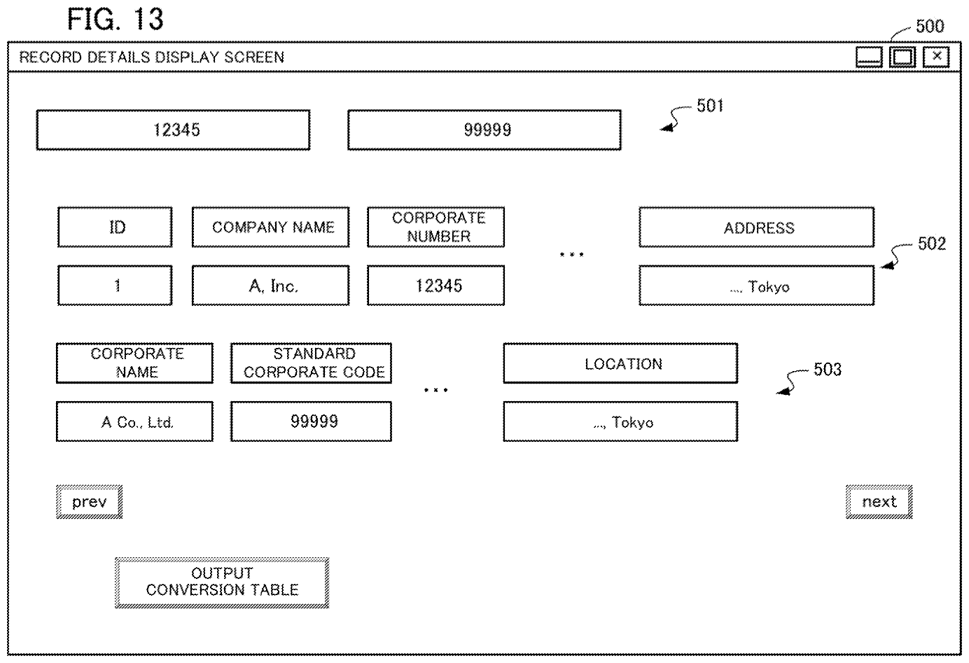

FIG. 13 illustrates an example of a record details display screen.

A record details display screen 500 is designed to display the details of a pair of matching source record and matching target record. When receiving a notification from the user terminal 41 that the “Confirm Details of Selected Record Pair” button has been pressed in the similar record search screen 300, the screen display control unit 120 causes the user terminal 41 to display the record details display screen 500. In addition, when receiving a notification from the user terminal 41 that a record has been selected in the individual company master record display area 401 of the record pair list display screen 400, the screen display control unit 120 also causes the user terminal 41 to display the record details display screen 500. The record details display screen 500 includes a conversion item display area 501, a matching source record display area 502, and a matching target record display area 503.

The conversion item display area 501 displays information about the conversion item in a matching source record and information about the conversion item in a matching target record. The matching source record display area 502 displays the items defined in the individual company master 112 and the information about the items registered in the matching source record. The matching target record display area 503 displays the items defined in the standard master 111 and the information about the items registered in the matching target record.

In addition, the record details display screen 500 includes an “Output Conversion Table” button. When receiving a notification from the user terminal 41 that the “Output Conversion Table” button has been pressed, the screen display control unit 120 causes the conversion table output unit 140 to generate a code conversion table indicating the corresponding relationship between the conversion item of each matching source record and the conversion item of each matching target record. The conversion table output unit 140 generates the code conversion table and stores it in the storage unit 110.

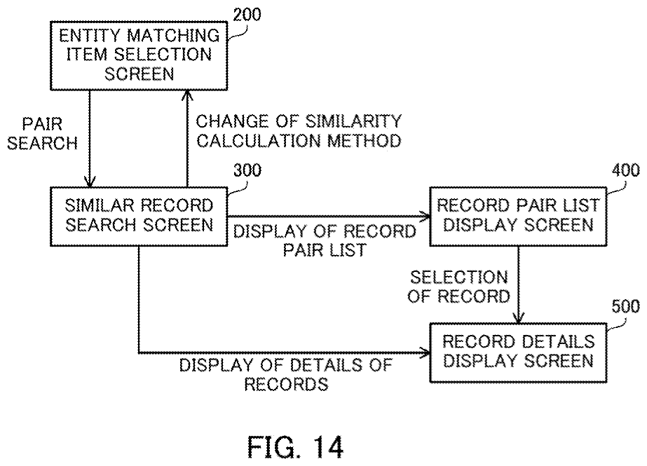

FIG. 14 illustrates an example of screen transitions.

The screen display control unit 120 causes the user terminal 41 to display the entity matching item selection screen 200, similar record search screen 300, record pair list display screen 400, and record details display screen 500.

First, the screen display control unit 120 causes the user terminal 41 to display the entity matching item selection screen 200 in response to an access from the user terminal 41. When receiving a notification from the user terminal 41 that the “Execute Entity Matching” button has been pressed in the entity matching item selection screen 200 (that is, a pair search is requested), the screen display control unit 120 causes the user terminal 41 to display the similar record search screen 300.

When receiving, from the user terminal 41 displaying the similar record search screen 300, a request for returning the screen back to the entity matching item selection screen 200 (that is, a change of similarity calculation method is requested), the screen display control unit 120 causes the user terminal 41 to display the entity matching item selection screen 200. When receiving a notification from the user terminal 41 displaying the similar record search screen 300 that the “Display Record Pair List” button has been pressed, the screen display control unit 120 causes the user terminal 41 to display the record pair list display screen 400. In addition, when receiving a notification from the user terminal 41 displaying the similar record search screen 300 that the “Confirm Details of Selected Record Pair” button has been pressed, the screen display control unit 120 causes the user terminal 41 to display the record details display screen 500.

When receiving a notification from the user terminal 41 displaying the record pair list display screen 400 that a record has been selected in the individual company master record display area 401, the screen display control unit 120 causes the user terminal 41 to display the record details display screen 500.

The following describes how the server 100 operates.

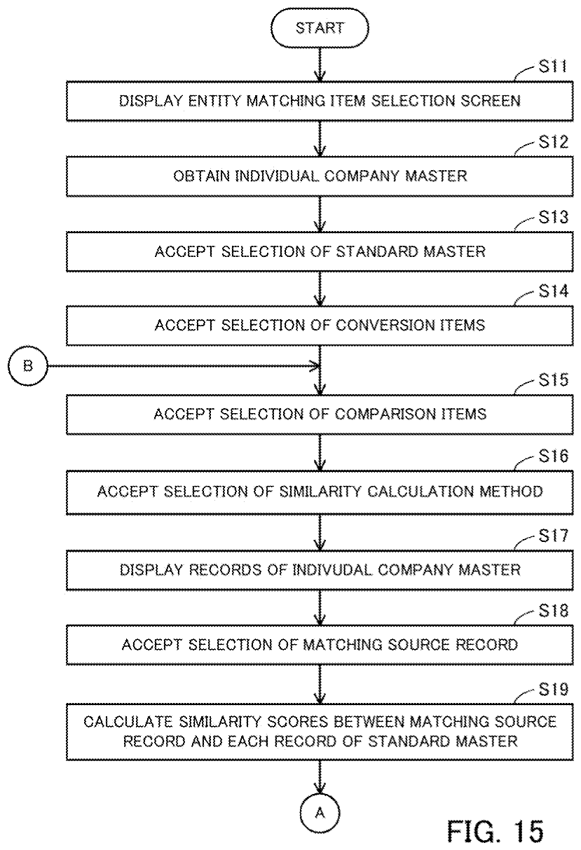

FIG. 15 is a first flowchart illustrating the operation of the server.

(S11) The screen display control unit 120 causes the user terminal 41 to display the entity matching item selection screen 200.

(S12) The screen display control unit 120 obtains the individual company master 112. More specifically, the screen display control unit 120 receives the individual company master 112 uploaded from the user terminal 41 to the server 100, and stores the individual company master 112 in the storage unit 110. The screen display control unit 120 then causes the user terminal 41 to display a sample record of the individual company master 112 in the individual company master display area 202 of the entity matching item selection screen 200.

(S13) The screen display control unit 120 accepts the selection of a standard master. When receiving a notification from the user terminal 41 that the standard master 111 has been selected, the screen display control unit 120 causes the user terminal 41 to display a sample record of the standard master 111 in the standard master display area 203 of the entity matching item selection screen 200.

(S14) The screen display control unit 120 accepts the selection of a conversion item for the standard master 111 and a conversion item for the individual company master 112. More specifically, the screen display control unit 120 receives from the user terminal 41 a notification of the conversion items selected for the standard master 111 and individual company master 112 in the entity matching item selection screen 200. Then, the screen display control unit 120 causes the user terminal 41 to display the conversion item for the individual company master 112 in the conversion item display area 205 of the entity matching item selection screen 200. In addition, the screen display control unit 120 causes the user terminal 41 to display the conversion item for the standard master 111 in the conversion item display area 206 of the entity matching item selection screen 200.

(S15) The screen display control unit 120 accepts the selection of a comparison item for the standard master 111 and a comparison item for the individual company master 112. More specifically, the screen display control unit 120 receives from the user terminal 41 a notification of a combination of comparison items selected in the entity matching item selection screen 200. Then, the screen display control unit 120 causes the user terminal 41 to display the combination of the comparison items side by side in the comparison item display area 204.

(S16) The screen display control unit 120 accepts the selection of a similarity calculation method. More specifically, the screen display control unit 120 receives from the user terminal 41 a notification of the similarity calculation method selected in the entity matching item selection screen 200.

Note that the above steps S14 to S16 may be executed in any order. That is to say, the screen display control unit 120 may accept the selection of conversion items, the selection of comparison items, and the selection of a similarity calculation method in any order. Alternatively, the screen display control unit 120 may accept the selections of the conversion items, comparison items, and similarity calculation method all together.

(S17) The screen display control unit 120 causes the user terminal 41 to display records of the individual company master 112. More specifically, when receiving a notification from the user terminal 41 that the “Execute Entity Matching” button has been pressed in the entity matching item selection screen 200, the screen display control unit 120 causes the user terminal 41 to display the similar record search screen 300. Then, the screen display control unit 120 causes the user terminal 41 to display the information about the comparison items and the information about the conversion item for each record of the individual company master 112 in the individual company master record display area 301 of the similar record search screen 300.

(S18) The screen display control unit 120 accepts the selection of a matching source record. More specifically, the screen display control unit 120 receives from the user terminal 41 a notification of the matching source record selected in the similar record search screen 300.

(S19) The similarity calculation unit 130 calculates the similarity scores between the selected matching source record accepted at step S18 and each record of the standard master 111. At this time, the similarity calculation unit 130 calculates the similarity scores between the matching source record and each record of the standard master 111 on the basis of the selected comparison items accepted at step S15 and the selected similarity calculation method accepted at step S16.

For example, the similarity calculation unit 130 calculates an index indicating the degree of matching between the text registered in the comparison item of the matching source record and the text registered in the comparison item of a record of the standard master 111 as a similarity score. To this end, the similarity calculation unit 130 may convert predetermined words included in the texts to other words (for example, “, Inc.” to “Co., Ltd.”), and then compare the texts registered in the comparison items to calculate the similarity score. A dictionary for the word conversion may depend on a similarity calculation method. In addition, the similarity calculation unit 130 may calculate the similarity score on the basis of the total number of records in the standard master 111 and the position of the record in the ranking of similarity to the matching source record among the records of the standard master 111. Then, the process proceeds to step S20.

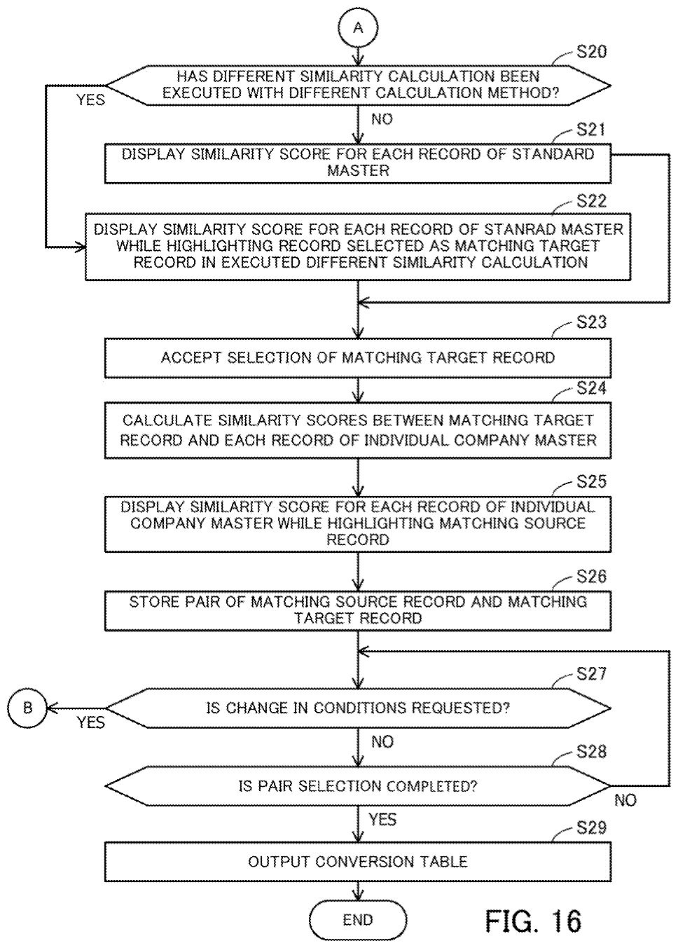

FIG. 16 is a second flowchart illustrating the operation of the server.

(S20) The similarity calculation unit 130 determines whether similarity calculation (hereinafter, executed different similarity calculation) has been executed with a similarity calculation method different from the selected similarity calculation method accepted at step S16, to calculate the similarity scores between the matching source record and each record of the standard master 111. If such executed different similarity calculation has been executed, the process proceeds to step S22. If such executed different similarity calculation has not been executed, the process proceeds to step S21.

(S21) The screen display control unit 120 causes the user terminal 41 to display the similarity scores between the matching source record and each record of the standard master 111. More specifically, the screen display control unit 120 causes the user terminal 41 to display, for each record of the standard master 111, the information about the comparison items, the information about the conversion item, and the similarity score between the matching source record and the record in the standard master record display area 302 of the similar record search screen 300. Then, the process proceeds to step S23.

(S22) The screen display control unit 120 causes the user terminal 41 to display the similarity scores between the matching source record and each record of the standard master 111 while highlighting the record selected as the matching target record in the executed different similarity calculation. More specifically, the screen display control unit 120 causes the user terminal 41 to display, for each record of the standard master 111, the information about the comparison items, the information about the conversion item, and the similarity score between the matching source record and the record in the standard master record display area 302 of the similar record search screen 300. Here, among the information on the records displayed in the standard master record display area 302, the screen display control unit 120 causes the user terminal 41 to highlight the information on the record selected as the matching target record in the executed different similarity calculation.

(S23) The screen display control unit 120 accepts the selection of a matching target record. More specifically, the screen display control unit 120 receives from the user terminal 41 a notification of the matching target record selected in the similar record search screen 300.

(S24) The similarity calculation unit 130 calculates the similarity scores between the selected matching target record accepted at step S23 and each record of the individual company master 112. Here, the similarity unit calculation 130 calculates the similarity scores between the matching target record and each record of the individual company master 112 on the basis of the selected comparison items accepted at step S15 and the selected similarity calculation method accepted at step S16.

In this connection, the similarity calculation unit 130 may calculate a similarity score on the basis of the total number of records in the individual company master 112 and the position of a record in the ranking of similarity to the matching target record among the records of the individual company master 112. Here, the total number of records in the standard master 111 and the total number of records in the individual company master 112 may be different. Therefore, the similarity score calculated between the matching source record and the matching target record at step S20 may have a different value from the similarity score calculated between the matching source record and the matching target record at step S24.

(S25) The screen display control unit 120 causes the user terminal 41 to display the similarity scores between the matching target record and each record of the individual company master 112 while highlighting the selected matching source record accepted at step S18. More specifically, the screen display control unit 120 causes the user terminal 41 to display, for each record of the individual company master 112, the information about the comparison items, the information about the conversion item, and the similarity score between the matching target record and the record in the individual company master record display area 303 of the similar record search screen 300. Here, among the information on the records displayed in the individual company master record display area 303, the screen display control unit 120 causes the user terminal 41 to highlight the information on the matching source record.

(S26) The conversion table output unit 140 stores information indicating that the matching source record and the matching target record are paired, in the storage unit 110. In this connection, if information indicating that the matching source record or the matching target record is paired with another record has been stored in the storage unit 110, the conversion table output unit 140 deletes the information indicating that the matching source record or the matching target record is paired with the other record.

(S27) The screen display control unit 120 determines whether a change in conditions has been requested. More specifically, when receiving from the user terminal 41 a request for returning the screen back to the entity matching item selection screen 200, the screen display control unit 120 determines that a change in conditions has been requested. When not receiving a request for returning the screen back to the entity matching item selection screen 200, the screen display control unit 120 determines that a change in conditions has not been requested. If the screen display control unit 120 determines that a change in conditions has been requested, the process proceeds to step S15. If the screen display control unit 120 determines that a change in conditions has not been requested, the process proceeds to step S28.

(S28) The screen display control unit 120 determines whether an input indicating the completion of pair selection has arrived. More specifically, when receiving a notification from the user terminal 41 that the “Output Conversion Table” button has been pressed in the record pair list display screen 400 or the record details display screen 500, the screen display control unit 120 determines that an input indicating the completion of pair selection has arrived. In addition, if there is no notification from the user terminal 41 that the “Output Conversion Table” button has been pressed, the screen display control unit 120 determines that an indicating input the completion of pair selection has not arrived. If the screen display control unit 120 determines that an input indicating the completion of pair selection has arrived, the process proceeds to step S29. If the screen display control unit 120 determines that an input indicating the completion of pair selection has not arrived, the process proceeds to step S27.

(S29) The conversion table output unit 140 outputs a code conversion table. More specifically, the conversion table output unit 140 identifies each pair of records, one from the standard master 111 and the other from the individual company master 112, on the basis of the information indicating the pairs stored in the storage unit 110. The conversion table output unit 140 then generates a code conversion table that links the information registered in the selected conversion items accepted at step S14 in the identified paired records to each other. Then, the conversion table output unit 140 stores the generated code conversion table in the storage unit 110.

In the manner described above, the screen display control unit 120 assists the user in the entity matching task by causing the user terminal 41 to display the similar record search screen 300. By doing so, the screen display control unit 120 alleviates the user's workload in the entity matching task.

In addition, the screen display control unit 120 is also able to accept a change in conditions such as the similarity calculation method and cause the user terminal 41 to display the similarity scores between the matching source record and each record of the standard master 111, which are calculated with the different similarity calculation method. By doing so, the screen display control unit 120 is able to present the plurality of determination criteria in the entity matching to the user. By doing so, the screen display control unit 120 is able to improve the accuracy of the entity matching.

At this time, the screen display control unit 120 causes the user terminal 41 to highlight the record selected as the matching target record in the previous similarity score display. By doing so, the screen display control unit 120 enables the user to easily confirm the record previously determined to have a corresponding relationship with the matching source record.

The following describes how to assist the user in the entity matching task using the similar record search screen 300.

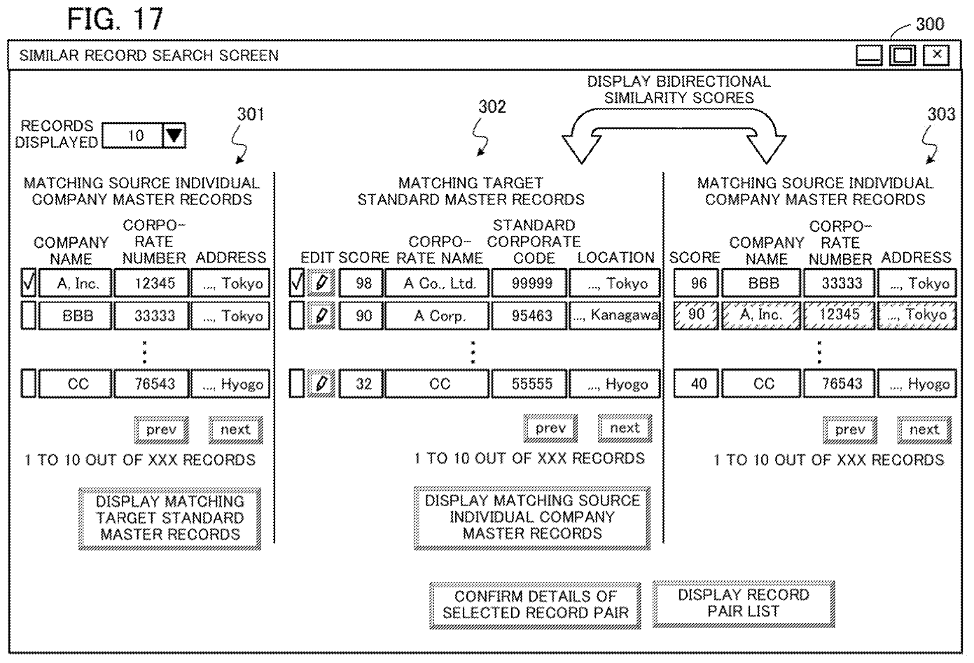

FIG. 17 is a view for describing how the server assists the entity matching task.

When a matching source record has been selected, the screen display control unit 120 causes the user terminal 41 to display, for each record of the standard master 111, the similarity score between the matching source record and the record in the standard master record display area 302 of the similar record search screen 300. By doing so, the screen display control unit 120 enables the user operating the user terminal 41 to confirm the similarity scores between the matching source record and each record of the standard master 111 and to select a matching target record that is highly likely to be matched to the matching source record.

When the matching target record has been selected, the screen display control unit 120 causes the user terminal 41 to display, for each record of the individual company master 112, the similarity score between the matching target record and the record in the individual company master record display area 303 of the similar record search screen 300. By doing so, the screen display control unit 120 enables the user to confirm how likely the matching source record is to have a corresponding relationship with the matching target record among the records of the individual company master 112.

By displaying such bidirectional similarity scores, the screen display control unit 120 enables the user to determine whether the matching source record and matching target record have a corresponding relationship with each other, without confirming the details of the matching source record and matching target record. Thus, the screen display control unit 120 enables the user to identify matching records in the entity matching efficiently.

In addition, the screen display control unit 120 causes the user terminal 41 to display, for each record of the individual company master 112, the similarity score between the matching target record and the record while highlighting the matching source record. By doing so, the screen display control unit 120 enables the user to easily confirm the similarity score between the matching target record and the matching source record among the similarity scores between the matching target record and each record of the individual company master 112. In the manner described above, the server 100 is able to assist the user to carry out the entity matching task smoothly.

The following describes the code conversion table.

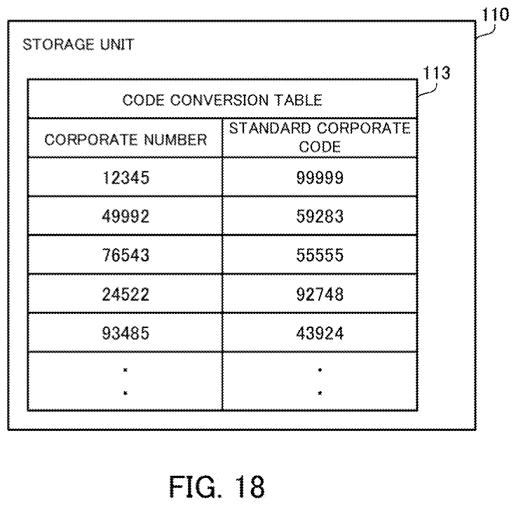

FIG. 18 illustrates an example of the code conversion table.

A code conversion table 113 is generated by the conversion table output unit 140 and is stored in the storage unit 110. In this connection, the code conversion table 113 illustrated in FIG. 18 is a table generated when the Standard Corporate Code item is selected as a conversion item for the standard master 111 and the Corporate Number item is selected as a conversion item for the individual company master 112. The code conversion table 113 has the following items: Corporate Number and Standard Corporate Code.

The Corporate Number item indicates the information registered in the Corporate Number item of a record included in a pair in the individual company master 112. The Standard Corporate Code item indicates the information registered in the Standard Corporate Code item of a record included in the pair in the standard master 111.

For example, the code conversion table 113 includes a record with Corporate Number of “12345” and Standard Corporate Code of “99999.” This record indicates that the record with Corporate Number of “12345” in the individual company master 112 and the record with Standard Corporate Code of “99999” in the standard master 111 are paired.

In this connection, the server 100 is able to send the code conversion table 113 to the user terminal 41. With the code conversion table 113, the user terminal 41 is able to find a record of the standard master 111 corresponding to a record of the individual company master 112. In addition, for example, the individual company side is able to correctly convert a corporate number to a standard corporate code for a record to be registered in the standard master 111. Thus, the conversion table output unit 140 generates this code conversion table 113 to make it possible to easily convert a record for registration in the standard master 111 and to facilitate data exchange between companies via the server 100.

According to the second embodiment, the server 100 performs the following processing. The storage unit 110 stores first data including a plurality of first records and second data including a plurality of second records.

When a first record has been selected from the first data, the screen display control unit 120 causes a display device to display, for each of the plurality of second records, a first similarity score between the selected first record and the second record. When a second record has been selected from the second data after the displaying of the first similarity scores, the screen display control unit 120 causes the display device to display, for each of the plurality of first records, a second similarity score between the selected second record and the first record, together with the first similarity score for each second record.

Here, the individual company master 112 is an example of the first data. The standard master 111 is an example of the second data. The user terminal 41 is an example of the display device. The matching source record is an example of the selected first record. The matching target record is an example of the selected second record.

In the manner described above, the server 100 enables the user doing the entity matching task to confirm the first similarity scores and select a second record that is highly likely to have a corresponding relationship with a first record, from the plurality of second records. In addition, after selecting the second record, the user is able to confirm the second similarity scores displayed together with the first similarity scores to confirm whether the selected first record is highly likely to have a corresponding relationship with the second record among the plurality of first records. Therefore, the user is able to determine whether the selected first record and the selected second record have a corresponding relationship, without confirming the details of the selected first and second records. Thus, the server 100 enables the user to identify matching records efficiently. In addition, the server 100 is able to alleviate the user's workload in the entity matching task.

In addition, the screen display control unit 120 highlights and displays the first record selected for displaying the first similarity scores. By doing so, the server 100 enables the user to easily confirm the second similarity score between the selected second record and the selected first record.

Further, there is a case where a calculation method different from the calculation method used for calculating the first similarity scores and second similarity scores is selected after the second similarity scores are displayed. In this case, the screen display control unit 120 causes the display device to display, for each of the plurality of second records, the third similarity score between the first record selected for displaying the first similarity scores and the second record, calculated with the different calculation method. By doing so, the server 100 is able to present the plurality of determination criteria in the entity matching to the user. Thus, the server 100 is able to improve the accuracy of the entity matching.

In addition, the screen display control unit 120 causes the display device to display the third similarity scores for the respective second records, in place of the first similarity scores, while highlighting the second record selected for displaying the second similarity scores. By doing so, the server 100 enables the user to easily confirm the second record previously determined to have a corresponding relationship with the first record.

Still further, when a first record and a second record have been selected as a pair after displaying of the first similarity scores, the conversion table output unit 140 stores information indicating the pair in the storage unit. By doing so, the server 100 is able to save the user's entity matching result.

Still further, when receiving an input indicating the completion of pair selection from the plurality of first records and the plurality of second records, the conversion table output unit 140 identifies first and second records forming each of the pairs stored in the storage unit 110. Then, the conversion table output unit 140 outputs information indicating the corresponding relationship between the information about a first data item included in each identified first record and the information about a second data item included in each identified second record. By doing so, for example, the server 100 is able to easily convert the information about the first data item in a record including the information about the first data item to information about the second data item. For example, the server 100 makes it easy to convert the information about the first data item in a record managed by a certain user to information about the second data item in a record managed by another user or in a standard record, so as to facilitate the data exchange between the users. In this connection, the conversion item for the individual company master 112 is an example of the first data item. In addition, the conversion item for the standard master 111 is an example of the second data item.

In this connection, the information processing of the first embodiment may be implemented by the processing unit 12 executing programs. In addition, the information processing of the second embodiment may be implemented by the CPU 101 executing programs. Such programs may be recorded on the computer-readable storage medium 33.

For example, storage media 33 on which the programs are recorded are distributed, so that the programs are distributed. In addition, the programs may be stored in another computer, which then distributes the programs over a network. For example, a computer stores (installs) the programs recorded on the storage medium 33 or programs received from the other computer in a local storage device such as the RAM 102 or HDD 103, and reads the programs from the storage device and executes the programs.

According to one aspect, it is achieved to identify matching records efficiently.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
causing, in response to a first record being selected from first data including a plurality of first records, a display device to display, for each of a plurality of second records included in second data, a first similarity score between the selected first record and the each of the plurality of second records; and
causing, in response to a second record being selected from the second data after displaying of the first similarity score, the display device to display, for each of the plurality of first records, a second similarity score between the selected second record and the each of the plurality of first records, together with the first similarity score for the each of the plurality of second records.

2. The non-transitory computer-readable storage medium according to claim 1, wherein displaying of the second similarity score includes highlighting and displaying the first record selected for displaying the first similarity score.

3. The non-transitory computer-readable storage medium according to claim 1, wherein:
the first similarity score and the second similarity score are calculated with a first calculation method; and
the process further includes causing, in response to a second calculation method being selected after displaying of the second similarity score, the second calculation method being different from the first calculation method, the display device to display, for each of the plurality of second records, a third similarity score between the first record selected for displaying the first similarity score and the each of the plurality of second records, the third similarity score being calculated with the second calculation method.

4. The non-transitory computer-readable storage medium according to claim 3, wherein displaying of the third similarity score includes displaying, in place of the first similarity score, the third similarity score for each of the plurality of second records while highlighting the second record selected for displaying the second similarity score.

5. The non-transitory computer-readable storage medium according to claim 1, wherein the process further includes storing, in response to the first record and the second record being selected as a pair after the displaying of the first similarity score, information indicating the pair in a memory.

6. The non-transitory computer-readable storage medium according to claim 5, wherein the process further includes
identifying, upon receiving an input indicating completion of selection of the pair from the plurality of first records and the plurality of second records, the first record and the second record forming the pair stored in the memory, and
outputting information indicating a corresponding relationship between information about a first data item included in the identified first record and information about a second data item included in the identified second record.

7. An information processing method comprising:
causing, by a processor, in response to a first record being selected from first data including a plurality of first records, a display device to display, for each of a plurality of second records included in second data, a first similarity y score between the selected first record and the each of the plurality of second records; and
causing, by the processor, in response to a second record being selected from the second data after displaying of the first similarity score, the display device to display, for each of the plurality of first records, a second similarity score between the selected second record and the each of the plurality of first records, together with the first similarity score for the each of the plurality of second records.

8. An information processing apparatus comprising:
a memory that stores first data including a plurality of first records and second data including a plurality of second records; and
a processor coupled to the memory and the processor configured to:
cause, in response to a first record being selected from the first data, a display device to display, for each of the plurality of second records, a first similarity score between the selected first record and the each of the plurality of second records; and
cause, in response to a second record being selected from the second data after displaying of the first similarity score, the display device to display, for each of the plurality of first records, a second similarity score between the selected second record and the each of the plurality of first records, together with the first similarity score for the each of the plurality of second records.
